(19) United States
(12) Patent Application Publication
(10) Pub. No.: US 2017/0242449 A1
(43) Pub. Date: Aug. 24, 2017

(54) LOW-DROPOUT LINEAR REGULATOR

(71) Applicant: MediaTek Singapore Pte. Ltd., Singapore (SG)

(72) Inventor: Ying-Chi CHEN, Luye Township (TW)

(21) Appl. No.: 15/435,430

(22) Filed: Feb. 17, 2017

(30) Foreign Application Priority Data
Feb. 22, 2016 (CN) 201610096692.3
Feb. 22, 2016 (CN) 201610097437.0

(51) Int. Cl. G05F 1/575

(52) U.S. Cl. CPC G05F 1/575

(57) ABSTRACT

A low-dropout linear regulator is provided. The low-dropout linear regulator includes: a voltage divider, a first error amplifier, an output transistor, a differential circuit, and a control circuit. The voltage divider generates a feedback voltage according to an output voltage of the low-dropout linear regulator. The first error amplifier compares the feedback voltage with a reference voltage, and outputs a first voltage at an output terminal of the first error amplifier according to the comparison result. The output transistor includes a first terminal receiving the first voltage, and a second terminal outputting the output voltage. The differential circuit receives the feedback voltage and the reference voltage, and generates a second voltage on its output terminal. The control circuit adjusts a voltage on the first terminal of the output transistor according to variation of the second voltage.

### CROSS REFERENCE TO RELATED APPLICATIONS

This Application claims priority of China Patent Application No. 201610097437.0, filed on Feb. 22, 2016, and China Patent Application No. 201610096692.3, file on Feb. 22, 2016, the entirety of which are incorporated by reference herein.

### FIELD OF THE INVENTION

The present invention relates to power management technologies, and, in particular, to a low-dropout linear regulator (LDO).

### BACKGROUND

Low-dropout regulators have the advantages of having a low cost, a steady output voltage, low-output voltage ripple, low noise, and no electromagnetic interference, and thus they are widely used in communication equipment, vehicle electronic products, and medical equipment.

FIG. 1 is a diagram of a conventional low-dropout linear regulator. As shown in FIG. 1, the conventional low-dropout linear regulator includes an error amplifier EA1, a voltage divider, and an output transistor T. A feedback voltage V_{FB} is obtained by dividing the output voltage V_{O} with the voltage divider (i.e. including resistors R2 and R3). An input terminal of the error amplifier EA1 receives the feedback voltage V_{FB}, and another input terminal of the error amplifier EA1 receives the reference voltage V_{REF}. The output terminal of the error amplifier EA1 is connected to the gate of the output transistor T. The error amplifier EA1 compares the feedback voltage V_{FB} with the reference voltage V_{REF}, and amplifies the difference between the feedback voltage V_{FB} and the reference voltage V_{REF} to drive the gate of the output transistor T.

When the output voltage V_{O} changes due to load conditions and other situations, the output voltage of the error amplifier EA1 is changed accordingly to control the conduction of the output transistor T, resulting in a steady output voltage V_{O}.

However, when the output voltage V_{O} changes due to external situations such as load conditions, the response time for the voltage change is an important factor in the performance of the low-dropout linear regulator. For example, when the load current changes dramatically, the output voltage V_{O} also changes dramatically. The change of the output voltage V_{O} is fed back to the input terminal of the error amplifier EA1 via the resistors of the voltage divider. However, the error amplifier EA1 may need a certain amount of time to respond to the voltage change, so that the gate of the output transistor T cannot respond to the rapid change of the output voltage in time, resulting in poor stability of the output voltage and response characteristics of the low-dropout linear regulator.

### BRIEF SUMMARY OF THE INVENTION

Accordingly, a low-dropout linear regulator is provided in the invention. The low-dropout linear regulator has a faster response time and is capable of rapidly suppressing changes of the output voltage of the low-dropout linear regulator.

In an exemplary embodiment, a low-dropout linear regulator is provided. The low-dropout linear regulator comprises: a voltage divider, a first error amplifier, an output transistor, a differential circuit, and a control circuit. The voltage divider is configured to generate a feedback voltage according to an output voltage of the low-dropout linear regulator. The first error amplifier is configured to compare the feedback voltage with a reference voltage, and output a first voltage at an output terminal of the first error amplifier according to the comparison result. The output transistor comprises a first terminal and a second terminal, wherein the first terminal is coupled to the output terminal of the first error amplifier and receives the first voltage, and the second terminal is coupled to the voltage divider and outputs the output voltage. The differential circuit is configured to receive the feedback voltage and the reference voltage, and generates a second voltage on an output terminal of the differential circuit. The control circuit is coupled between the output terminal of the differential circuit and the first terminal of the output transistor, and is configured to adjust a voltage at the first terminal of the output transistor according to variations of the second voltage at the output terminal of the differential circuit.

In another exemplary embodiment, a low-dropout linear regulator is provided. The low-dropout linear regulator comprises a voltage divider, a first negative feedback loop, a second negative feedback loop, and an output transistor. The voltage divider is configured to generate a feedback voltage according to an output voltage of the low-dropout linear regulator. The first negative feedback loop comprises an error amplifier and is configured to receive the feedback voltage and a reference voltage, and compare the feedback voltage with the reference voltage to output a first voltage. The second negative feedback loop comprises a differential circuit and a control circuit, and the differential circuit is configured to receive the feedback voltage and the reference voltage to generate a second voltage, and the control circuit is configured to adjust a voltage on the first terminal of the output transistor according to variation of the second voltage on the output terminal of the differential circuit. The output transistor comprises a first terminal and a second terminal, and the first terminal of the output transistor is coupled to an output terminal of the error amplifier and the control circuit and is configured to receive the first voltage and the second voltage, and the second terminal of the output transistor is used as an output terminal of the low-dropout linear regulator.

The low-dropout linear regulator of the invention has a faster response speed to suppress variation of the output voltage of the low-dropout linear regulator, thereby maintain the steadiness of the output voltage of the low-dropout linear regulator.

### BRIEF DESCRIPTION OF THE DRAWINGS

The present invention can be more fully understood by reading the subsequent detailed description and examples with references made to the accompanying drawings, wherein:

FIG. 1 is a diagram of a conventional low-dropout linear regulator;

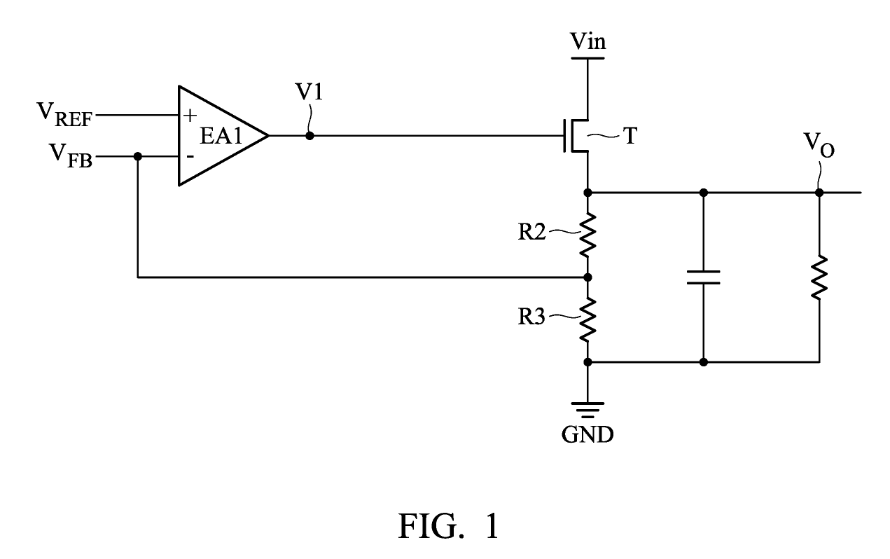

FIG. 2 is a schematic diagram of the low-dropout linear regulator in accordance with an embodiment of the invention;

FIG. 3 is a schematic diagram of the detecting and switching circuit in accordance with an embodiment of the invention;

FIG. 4 is a diagram of curves of the output current I_{O} of the output transistor T over time, the output voltage V_{O}′ of the conventional low-dropout linear regulator over time, the output voltage V_{O} of the low-dropout linear regulator of the invention, and the output voltage V2 of the differential circuit over time;

FIG. 5 is a schematic diagram of the low-dropout linear regulator in accordance with another embodiment of the invention; and

FIG. 6 is a diagram of curves of the output current I_{O} of the output transistor T of the low-dropout linear regulator in FIG. 5 over time, the output voltage V_{O}′ of the conventional low-dropout linear regulator over time, the output voltage V_{O} of the low-dropout linear regulator of the invention, and the driving voltage of the output transistor T over time.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

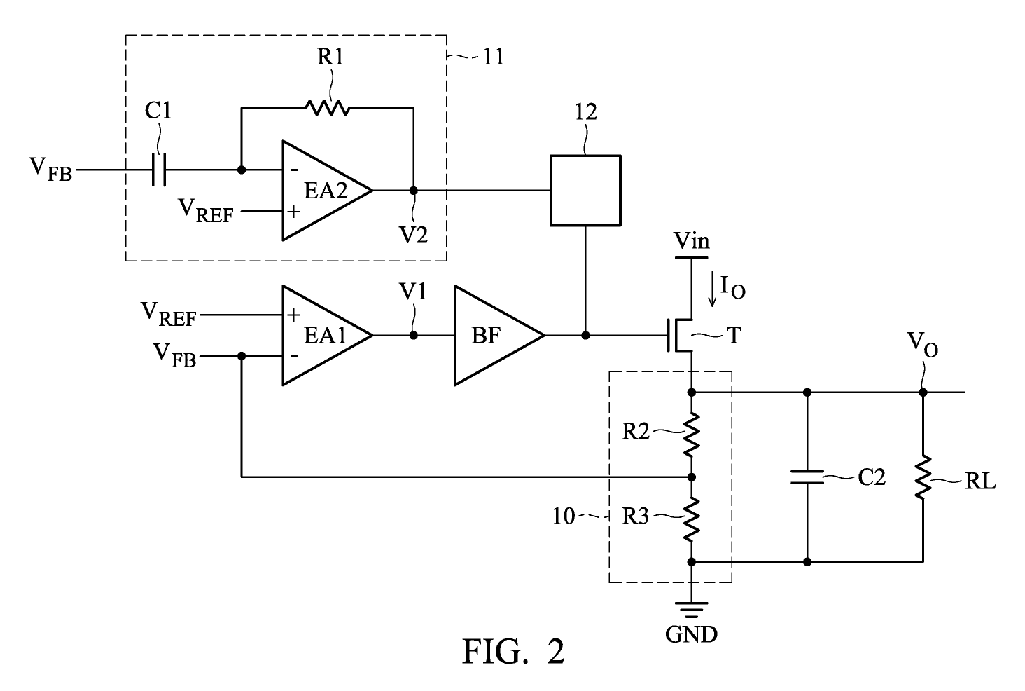

A low-dropout linear regulator is provided in the invention, as shown in FIG. 2. FIG. 2 is a schematic diagram of the low-dropout linear regulator in accordance with an embodiment of the invention. The low-dropout linear regulator includes a voltage divider 10, an error amplifier EA1, an output transistor T, a differential circuit 11, and a control circuit 12.

The voltage divider 10 generates a feedback voltage V_{FB} according to the output voltage of the low-dropout linear regulator. Specifically, the voltage divider 10 includes a resistor R2 and a resistor R3. A first terminal of the resistor R2 is connected to a second terminal of the output transistor T, and a second terminal of the resistor R2 is connected to a first terminal of the resistor R3, and a second terminal of the resistor R3 is connected to the ground GND. In the embodiment, the feedback voltage V_{FB} is output at the second terminal of the resistor R2 and the first terminal of the resistor R3. That is, the voltage across the resistor R3 is used as the feedback voltage V_{FB}. It should be noted that the resistance values of the resistors R2 and R3 can be adjusted according to practical situations.

The error amplifier EA1 compares the feedback voltage V_{FB} with the reference voltage V_{REF}, and output a first voltage V1 at the output terminal of the error amplifier EA1 according to the comparison result. In one embodiment, the positive input terminal of the error amplifier EA1 receives the reference voltage V_{REF}, and the negative input terminal of the error amplifier EA1 is coupled to the second terminal of the resistor R2 and the first terminal of the resistor R3 to receive the feedback voltage V_{FB}. Specifically, the error amplifier EA1 compares the feedback voltage V_{FB} and the reference voltage V_{REF}, and amplifies the difference between the feedback voltage V_{FB} and the reference voltage V_{REF} to output the first voltage V1 that is used to drive the output transistor T.

A first terminal of the output transistor T is connected to the output terminal of the error amplifier EA1, and a second terminal of the output transistor T is coupled to the voltage divider 10 to output the output voltage V_{O}. That is, the second terminal of the output transistor T is the output terminal of the low-dropout linear regulator, and a third terminal of the output transistor T is the input terminal of the low-dropout linear regulator for receiving the input voltage Vᵢₙ.

In the embodiment, the output transistor T may be an N-type MOSFET (NMOSFET). The first terminal of the output transistor T is the gate of the NMOSFET, and the second terminal of the output transistor T is the source of the NMOSFET, and the third terminal of the output transistor T is the drain of the NMOSFET.

It should be noted that the output transistor T may be an NPN transistor in some other embodiments. The first terminal of the output transistor T is the base electrode of the NPN transistor, and the second terminal of the output transistor T is the emitter electrode of the NPN transistor, and the third terminal of the output transistor T is the collector electrode of the NPN transistor.

In some embodiments, the low-dropout linear regulator in FIG. 2 may further include a buffer BF that is coupled between the output terminal of the error amplifier EA1 and the first terminal of the output transistor T.

In addition, in some embodiments, a capacitor C2 and a load resistor RL can be coupled in parallel between the output terminal of the low-dropout linear regulator and the ground. Specially, a terminal of the capacitor C2 is connected to the second terminal of the output transistor T, and another terminal of the capacitor C2 is connected to the ground. The capacitor C2 is an important element for storing and providing electric charges, and thus may effectively reduce the rapid falling and rising of the output voltage that is caused by a rapid change of the load current.

The differential circuit 11 is coupled to the voltage divider 10. The differential circuit 11 receives the feedback voltage V_{FB} and the reference voltage V_{REF}, and outputs a second voltage V2 at the output terminal of the differential circuit 11. The differential circuit 11 includes an error amplifier EA2, a capacitor C1, and a resistor R1. The positive input terminal of the error amplifier EA2 receives the reference voltage V_{REF}, and the negative input terminal of the error amplifier EA2 is coupled to the second terminal of the capacitor C1, and the output terminal of the error amplifier EA2 is used as the output terminal of the differential circuit 11. A first terminal of the capacitor C1 is used as the input terminal of the differential circuit 11 for receiving the feedback voltage V_{FB}, and the resistor R1 is coupled between the negative input terminal and output terminal of the error amplifier EA2.

The control circuit 12 is connected to the output terminal of the differential circuit 11 and the first terminal of the output transistor T, and is utilized to adjust the voltage at the first terminal of the output transistor T according to the second voltage V2 at the output terminal of the differential circuit 11, thereby controlling the conduction of the output transistor T for suppressing the variation of the output voltage V_{O} of the output transistor T.

Referring to FIG. 2, a first feedback loop is formed by the error amplifier EA1, the buffer BF, and the voltage divider 10, and a second feedback loop, that is parallel to the first feedback loop, is formed by the differential circuit 11, the control circuit 12, and the voltage divider 10. The input signals received by the second feedback loop are the same as those received by the first feedback loop. For example, the second feedback loop and the first feedback loop receive the feedback voltage V_{FB} and the reference voltage V_{REF} as the input signals.

In the embodiment, the feedback voltage V_{FB} is linearly proportional to the output voltage V_{O}, and the relationship between the feedback voltage V_{FB} and the output voltage V_{O} can be expressed by the following equation:

V_{FB}⁼V_{O}*R3/(R2+R3) (1)

The relationship between the output voltage and the input voltage of the differential circuit 11 can be expressed by the following equation:

$${v}_{o} ( t ) = - RC \frac{{dv}_{i} ( t )}{dt} \qquad ( 2 )$$

Wherein vᵢ(t) denotes the input voltage of the differential circuit 11, and vᵢ(t) is the feedback voltage V_{FB} in the embodiment. vₒ(t) denotes the voltage at the output terminal of the differential circuit 11, and vₒ(t) is the second voltage V2 in the embodiment. R denotes the resistance value of the resistor R1, and C denotes the capacitance value of the capacitor C1.

Referring to equations (1) and (2), the output voltage of the differential circuit 11 may change rapidly in response to a variation of the input voltage. That is, the output voltage of the differential circuit 11 is very sensitive to the input voltage.

Accordingly, compared to the error amplifier, the differential circuit 11 is capable of rapidly responding to sudden changes in the input voltage. Thus, compared with the first feedback loop including the error amplifier EA1, the second feedback loop including the differential circuit 11 may much more rapidly respond to a variation of the input voltage. Referring to FIG. 2, the second feedback loop including the differential circuit 11 has already responded to a variation of the feedback voltage V_{FB} before the first feedback loop starts to suppress a variation of the output voltage V_{O}. Accordingly, compared with the first feedback loop, the second feedback loop may suppress the variation of the output voltage V_{O} more rapidly, thereby rapidly maintaining the steadiness of the output voltage V_{O}.

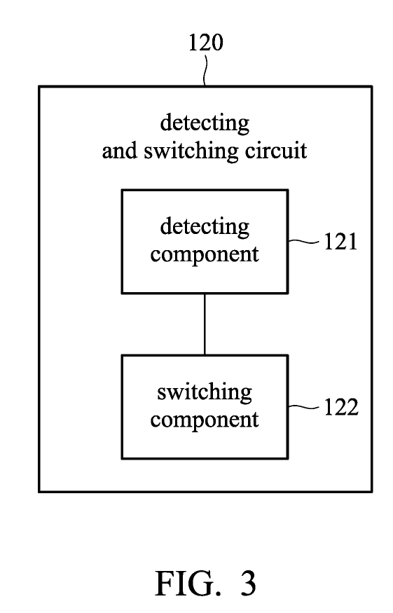

As shown in FIG. 3, in some embodiments, the control circuit 12 includes a detecting and switching circuit 120. When the detecting and switching circuit 120 has detected that the second voltage V2 from the output terminal of the differential circuit 11 exceeds a predetermined voltage range, the detecting and switching circuit 120 connects the output terminal of the differential circuit 11 to the first terminal of the output transistor T. When the detecting and switching circuit 120 has detected that the second voltage V2 from the output terminal of the differential circuit 11 is within the predetermined voltage range, the detecting and switching circuit 120 disconnects the output terminal of the differential circuit 11 from the first terminal of the output transistor T. It should be noted that the predetermined voltage range can be defined by the user according to practical situations.

Specifically, referring to FIG. 3, the detecting and switching circuit 120 may include a detecting component 121 and a switching component 122. The detecting component 121 is for detecting whether the second voltage V2 output from the differential circuit 11 exceeds the predetermined voltage range. If the second voltage V2 exceeds the predetermined voltage range, the switching component 122 is turned on, so that the output terminal of the differential circuit 11 is connected to the first terminal of the output transistor T. If the second voltage V2 is within the predetermined voltage range, the switching component 122 is turned off, so that the output terminal of the differential circuit 11 is disconnected from the first terminal of the output transistor T. It should be noted that one having ordinary skill in the art may implement the detecting and switching circuit 120 using well-known circuits in the art to achieve the same or similar functions of the detecting and switching circuit 120. Thus, a detailed description of the detecting and switching circuit 120 is omitted here.

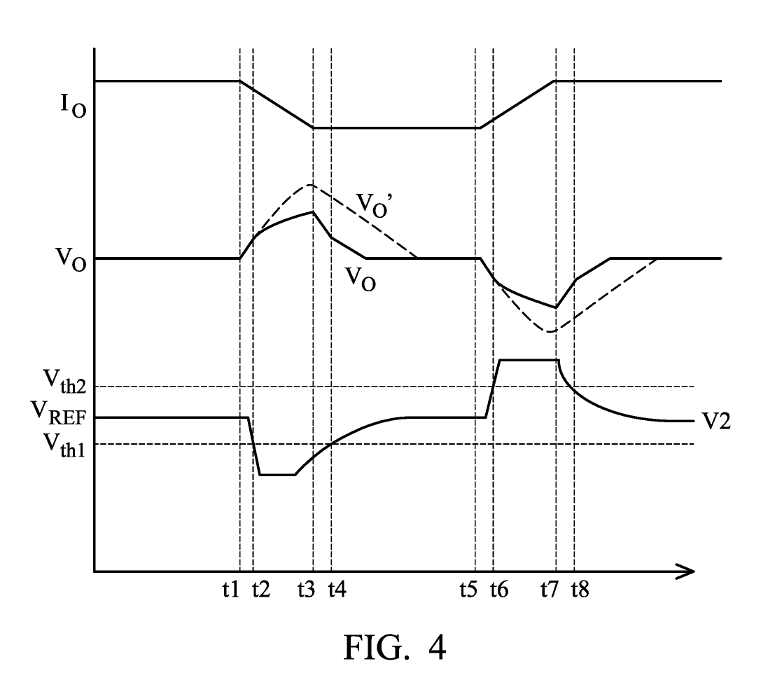

The operations of the low-dropout linear regulator are described with reference to FIG. 4. FIG. 4 is a diagram of curves of the output current I_{O} of the output transistor T over time, the output voltage V_{O}′ of the conventional low-dropout linear regulator over time, the output voltage V_{O} over time of the low-dropout linear regulator of the invention having the output transistor T connected with the differential circuit 11, and the output voltage V2 of the differential circuit 11 over time.

When the output voltage V_{O} is in a steady state, the feedback voltage V_{FB} and the reference voltage V_{REF} received by two input terminals of the error amplifier EA1 are equal. Meanwhile, the output value of the first voltage V1 is a fixed voltage Vᵢₙᵢₜᵢₐₗ dependent on the load current (i.e. output current) I_{O}. When the load connected to the low-dropout linear regulator is determined, the fixed voltage Vᵢₙᵢₜᵢₐₗ can be determined. When the output voltage Vo varies, the first voltage V1 output from the error amplifier EA1 is equal to the fixed voltage Vᵢₙᵢₜᵢₐₗ plus the amount of variation ΔV1.

Similarly, when the output voltage Vo is in a steady state, the feedback voltage V_{FB} and the reference voltage V_{REF} received by the differential circuit 11 are equal, and the second voltage V2 at the output terminal of differential circuit 11 is also equal to the feedback voltage V_{FB} and the reference voltage V_{REF}. Meanwhile, the detecting component 121 of the detecting and switching circuit 120 may detect that the second voltage V2 is within the predetermined voltage range, i.e., the variation of the second voltage V2 is zero, and the switching component 122 is turned off to disconnect the differential circuit 11 from the output transistor T. In other words, when the output voltage V_{O} is in a steady state, the second feedback loop is in a disconnected state. That is, when operating in a normal working state, the differential circuit 11 is isolated from the output voltage of the low-dropout linear regulator.

At time t1, the output current I_{O} decreases, the output voltage V_{O} increases from the steady state, and the feedback voltage V_{FB} also increases in proportion to the output voltage V_{O}. As shown in FIG. 4, since the negative input terminal of the error amplifier EA2 of the differential circuit 11 receives the feedback voltage V_{FB}, the second voltage V2 from the differential circuit 11 rapidly decreases. As described above, the response time of the differential circuit 11 to the feedback voltage V_{FB} is much shorter than that of the error amplifier EA1 to the feedback voltage V_{FB}, and thus the decrement rate of the second voltage V2 is greater than that of the first voltage V1.

After time t2, the detecting component 121 of the detecting and switching circuit 120 detects that the second voltage V2 is lower than a first voltage threshold Vₜₕ₁, and then the switching component 122 of the detecting and switching circuit 120 is turned on, so that the output terminal of the differential circuit 11 is connected to the first terminal of the output transistor T. The rapidly decreasing second voltage V2 makes the output transistor T enter a cut-off state, thereby rapidly limiting the increment of the output voltage V_{O}. In the embodiment, since the second voltage V2 decreases prior to the first voltage V1 output by the error amplifier EA1 changes, the increment rate of the output voltage Vo after time t2 becomes slower, and thus the variation of the output voltage Vo is suppressed earlier than the conventional low-dropout linear regulator to generate the output voltage Vo′ over time. At time t3, the output voltage V_{O} falls to a steady state after reaching the maximum value. Referring to FIG. 4, since the differential circuit may have a faster response speed to the output voltage than the error amplifier EA1, in the period between time t3 and t4, the output voltage Vo in the embodiment decreases to a steady state faster than the output voltage Vo′ in the conventional low-dropout linear regulator.

Accordingly, referring to FIG. 4, when the output voltage V_{O} starts to increase from a steady state, the switching component 122 of the detecting and switching circuit 120 is turned off during the period from time t1 to time t2, and thus the differential circuit 11 does not drive the output transistor T. The output voltage V_{O} in the embodiment is increased at the same rate as the output voltage V_{O}′ in the conventional low-dropout linear regulator. During the period between time t2 and time t4, the second voltage V2 exceeds the first voltage threshold Vth1, and the differential circuit 11 drives the output transistor T, and thus the second feedback loop including the differential circuit has a much faster response speed than the first feedback loop including the error amplifier EA1. Accordingly, the output voltage V_{O} in the embodiment has a lower increment speed and a faster decrement speed than the output voltage V_{O}′ in a conventional low-dropout linear regulator, and thus the output voltage V_{O} may reach the steady state at a faster speed. In the embodiment, because the output voltage V_{O} can re-enter a steady state with a faster speed, the response time of the low-dropout linear regulator can be significantly reduced. At time t5, the output current Io of the output transistor T gradually increases, the output voltage V_{O} gradually decreases from the steady state, and the feedback voltage V_{FB} is also proportionally decreased. As shown in FIG. 4, since the negative input terminal of the error amplifier EA2 of the differential circuit 11 receives the feedback voltage V_{FB}, the second voltage V2 of the differential circuit 11 increases rapidly. As described above, since the response speed of the differential circuit for the change of the feedback voltage V_{FB} is much faster than that of the error amplifier EA1, the increment rate of the second voltage V2 is higher than that of the first voltage V1.

After time t6, when the detecting component 121 of the detecting and switching circuit 120 detects that the second voltage V2 is higher than a second voltage threshold Vth2, the switching component 122 of the detecting and switching circuit 120 is turned on, so that the output terminal of the differential circuit 11 is connected to the first terminal of the output transistor T. Since the conduction of the output transistor T is controlled by the voltage on the first terminal of the output transistor T, when the conduction degree of the output transistor T is greater, more current is induced from the drain to the source of the output transistor T. Thus, the current from the drain to the source (i.e. the second terminal) of the output transistor T rapidly increases due to the fast-increasing second voltage V2, and the decrement rate of the output voltage V_{O} becomes slower. Compared to a conventional low-dropout linear regulator only having a first feedback loop, the decrement rate of the output voltage V_{O} of the low-dropout linear regulator of the invention becomes slower by the action of the second feedback loop including the differential circuit, thereby suppressing variations in the output voltage V_{O}.

At time t7, the output voltage increases to a steady state after reaching the minimum voltage. Referring to FIG. 4, during the period between time t7 and t8, the differential circuit always has a faster response speed for the change of the output voltage V_{O} than the error amplifier EA1. The output voltage Vo of the invention can return to the steady state at a faster speed than the output voltage V_{O}′ in a conventional low-dropout linear regulator.

Accordingly, referring to FIG. 4, during the period between time t5 and t6, when the output voltage V_{O} decreases from the steady state and does not exceed the second threshold Vₜₕ₂, the switching component 122 of the detecting and switching circuit 120 is turned off, and thus the differential circuit 11 does not drive the output transistor T. In the embodiment, the output voltage Vo of the invention and the output voltage V_{O}′ in a conventional low-dropout linear regulator have the same decrement rate. During the period between time t6 and t8, the second voltage V2 exceeds the second voltage threshold Vₜₕ₂, and the differential circuit 11 starts to drive the output transistor T. The response speed of the second feedback loop including the differential circuit 11 to the change of the output voltage V_{O} is much faster than that of the first feedback loop including the error amplifier EA1. Compared with the output voltage V_{O}′ in a conventional low-dropout linear regulator, the output voltage V_{O} of the invention has a slower decrement rate and a faster recovery speed, and thus the output voltage V_{O} of the invention can rapidly return to the steady state. Accordingly, the response time of the low-dropout linear regulator of the invention can be reduced significantly.

In an embodiment, when the second voltage V2 is within the range between the first voltage threshold Vₜₕ₁ and the second voltage threshold Vₜₕ₂, the differential circuit 11 and the output transistor T are disconnected by the switching component 122. When the second voltage V2 exceeds the range between the first voltage threshold Vₜₕ₁ and the second voltage threshold Vₜₕ₂, the switching component 122 is turned on, so that the differential circuit 11 is connected to the output transistor T. The first voltage threshold Vₜₕ₁ and the second voltage threshold V can be defined according to the allowable variation range of the output voltage V_{O}, and the values of the first voltage threshold Vₜₕ₁ and the second voltage threshold Vₜₕ₂ can also be defined according to the user's requirements.

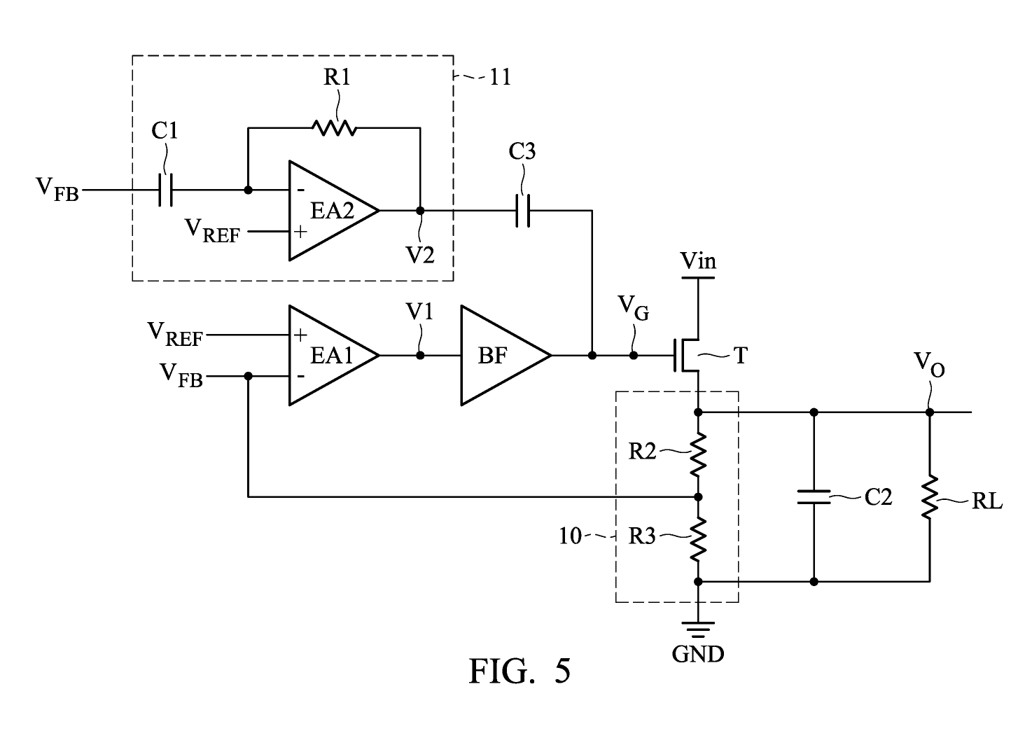

Alternatively, in some embodiments, the control circuit 12 may include a capacitor C3, as shown in FIG. 5. The first terminal of the capacitor C3 is connected to the output terminal of the differential circuit 11, and the second terminal of the capacitor C3 is connected to the first terminal of the output transistor T. Due to the characteristics of the capacitor C3, when the second voltage V2 on the output terminal of the differential circuit 11 varies, the voltage on the first terminal of the output transistor T may follow the variation of the second voltage V2 via the capacitor C3, thereby controlling the conduction degree of the output transistor T.

Specifically, in the normal working mode, the feedback voltage remains unchanged and is equal to the reference voltage V_{REF}. The voltages on the first terminal and the second terminal of the capacitor C3 are equal. Meanwhile, there is no ingoing current or outgoing current on the first terminal of the output transistor T, that is, the differential circuit 11 is disconnected from the output transistor T. When the normal working mode is changed, the output voltage V_{O} is changed, and thus the feedback voltage V_{FB} is changed accordingly, so that the second voltage V2 on the output terminal of the differential circuit 11 is also changed, resulting in the voltages on the first terminal and the second terminal of the capacitor C3 being unequal. Accordingly, there may be an ingoing current flowing from the output terminal of the differential circuit 11 to the first terminal of the output transistor T or an outgoing current flowing from the first terminal of the output transistor T, and thus the conduction of the output transistor T can be controlled. Thus, the output voltage V_{O} can be adjusted, thereby suppressing the variation of the output voltage V_{O}.

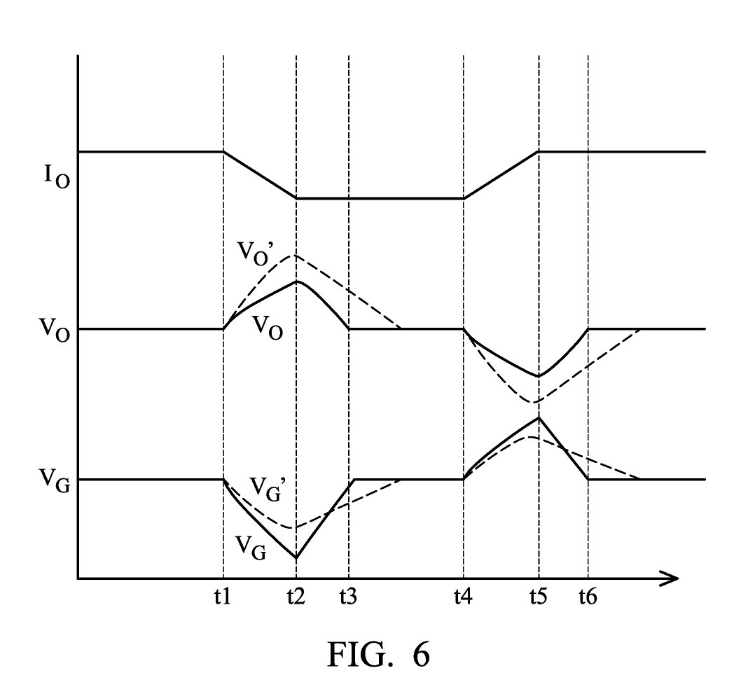

FIG. 6 is a diagram of curves of the output current I_{O} of the output transistor T of the low-dropout linear regulator in FIG. 5 over time, the output voltage V_{O}′ of the conventional low-dropout linear regulator over time, the output voltage V_{O} of the low-dropout linear regulator of the invention over time, and the driving voltage of the output transistor T over time.

Before time t1, the output voltage V_{O} is in a steady state, and the feedback voltage V_{FB} and the reference voltage V_{REF} received by two input terminals of the error amplifier EA1 are equal. Meanwhile, the first voltage V1 output from the error amplifier EA1 is a fixed value Vᵢₙᵢₜᵢₐₗ according to the load current (i.e. output current) Io. When the output voltage V_{O} varies, the first voltage V1 output from the error amplifier EA1 is equal to the fixed voltage Vᵢₙᵢₜᵢₐₗ plus the amount of variation ΔV1, and the voltage on the second terminal of the capacitor C3 equals the first voltage V1. Similarly, when the output voltage V_{O} is in a steady state, the feedback voltage V_{FB} and the reference voltage V_{REF} received by the differential circuit 11 are equal, and the second voltage V2 output from the differential circuit 11 is equal to the feedback voltage V_{FB} and the reference voltage V_{REF}, and the voltage on the first terminal of the capacitor C3 is the second voltage V2. At such condition, the two terminals of the capacitor C3 are in a steady state. That is, when the output voltage V_{O} is in a steady state, the second feedback loop is disconnected from the output transistor T. In other words, in the normal working mode, the differential circuit 11 is isolated from the output voltage V_{O} of the low-dropout linear regulator.

At time t1, the output current I_{O} of the output transistor T starts to gradually decrease, the output voltage V_{O} starts to increase from the steady state, and the feedback voltage V_{FB} also proportionally increases. Since the negative input terminal of the error amplifier EA2 of the differential circuit 11 receives the feedback voltage V_{FB}, the second voltage V2 output from the differential circuit 11 rapidly decreases. Because there is a delay for the first feedback loop to respond to variations of the output voltage Vo in comparison with the second feedback loop, the voltage on the second terminal of the capacitor C3 is temporarily unsynchronized with the voltage on the first terminal of the capacitor C3, and the voltage on the first terminal of the capacitor C3 rapidly decreases during this time. Due to the voltage continuity on two terminals of the capacitor, the voltage on the second terminal of the capacitor C3 decreases in response to the rapid decrement of the voltage on the first terminal of the capacitor C3. Accordingly, compared with the first feedback loop that does not include the differential circuit 11, the driving voltage on the first terminal of the output transistor T of the invention can be reduced at a faster speed, thereby controlling the conduction of the output transistor T earlier. Due to the functionality of the differential circuit 11, the second voltage V2 rapidly decreases earlier than the variation of the first voltage V1 output from the error amplifier EA1, thereby rapidly suppressing the increasing of the output voltage V_{O}.

In the first feedback loop, when the feedback voltage V_{FB} is proportionally increased, the first voltage V1 output from the error amplifier EA1 decreases because the feedback voltage V_{FB} is connected to the negative input terminal of the error amplifier EA1. The first feedback loop is parallel to the second feedback loop including the differential circuit 11, and both the first feedback loop and the second feedback loop are used together to control the output transistor T. Accordingly, compared to a conventional low-dropout linear regulator that only includes a first feedback loop, the low-dropout linear regulator includes the first feedback loop and the second feedback loop, and the first voltage V1 of the first feedback loop and the second voltage V2 of the second feedback loop can be used together to control the output transistor T, and thus the decrement rate of the driving voltage V_{G} of the output transistor T can be increased. As shown in FIG. 6, during the period between time t1 and t2, the decrement rate of the driving voltage V_{G} of the output transistor T of the invention is greater than that of the driving voltage V_{G}′ of the output transistor T in the conventional low-dropout linear regulator.

Accordingly, during the period between time t1 and t2, with the cooperation of the first feedback loop and the second feedback loop, the decrement rate of the driving voltage V_{G} of the output transistor T of the invention is greater than that of the driving voltage V_{G}′ in a conventional low-dropout linear regulator. Thus, the low-dropout linear regulator of the invention may suppress the increase of the output voltage V_{O} more effectively. As shown in FIG. 6, the increment rate of the output voltage V_{O} becomes slower when compared with the output voltage V_{O}′ in a conventional low-dropout linear regulator, and thus suppression of the variation of the output voltage V_{O} is stronger in the low-dropout linear regulator of the invention.

At time t2, the output voltage V_{O} starts to fall back to a steady state after reaching the maximum value. As shown in FIG. 6, during the period between time t2 and t3, compared with the conventional low-dropout linear regulator, the output voltage V_{O} of the low-dropout linear regulator of the invention decreases and returns to the steady state at a faster speed.

At time t4, the output current Io of the output transistor T starts to gradually increase, the output voltage Vo gradually decreases from the steady state, and the feedback voltage V_{FB} also proportionally decreases. Since the negative input terminal of the error amplifier EA2 of the differential circuit 11 receives the feedback voltage V_{FB}, the second voltage V2 of the differential circuit 11 increases rapidly, and the voltage on the first terminal of the capacitor C3 synchronously increases with the second voltage V2. Because there is a delay for the first feedback loop to respond to variations in the output voltage V_{O} in comparison with the second feedback loop, the voltage on the second terminal of the capacitor C3 is temporarily unsynchronized with the voltage on the first terminal of the capacitor C3. Due to the voltage continuity on two terminals of the capacitor, the voltage on the second terminal of the capacitor C3 increases in response to the rapid increment of the voltage on the first terminal of the capacitor C3. Accordingly, compared with only the first feedback loop without the differential circuit 11, the driving voltage V_{G} on the first terminal of the output transistor T of the invention may increase more earlier, thereby controlling the conduction of the output transistor T earlier. Because the driving voltage V_{G} controls the conduction degree of the output transistor T, thus from time t4, the driving voltage V_{G} starts to increase rapidly, as such the ingoing current to the output terminal of the output transistor T increases rapidly, thus pulling up the output voltage being gradually decreasing, thereby the decreasing of the output voltage V_{O} can be rapidly suppressed.

The first feedback loop is parallel to the second feedback loop including the differential circuit 11, and the first feedback loop and the second feedback loop are used together to control the output transistor T. Accordingly, with the cooperation of the first voltage V1 of the first feedback loop and the second voltage V2 of the second feedback loop, the driving voltage V_{G} of the output transistor T of the invention may increase at a faster speed than a conventional low-dropout linear regulator that only includes a first feedback loop. As shown in FIG. 6, during the period between time t4 and t5, the increment rate of the driving voltage V_{G} of the output transistor T is greater than that of the driving voltage V_{G}′ in the conventional low-dropout linear regulator.

During the period between time t4 and t5, with the cooperation of the first voltage V1 of the first feedback loop and the second voltage V2 of the second feedback loop, the driving voltage V_{G} of the output transistor T of the invention may increase at a faster speed than a conventional low-dropout linear regulator that only includes a first feedback loop. Accordingly, the decrease of the output voltage V_{O} can be suppressed more effectively in the invention. As shown in FIG. 6, the decrement rate of the output voltage V_{O} of the invention becomes slower than that of the output voltage V_{O}′ in the conventional low-dropout linear regulator that only includes a first feedback loop. That is, the suppression of the variation of the output voltage V_{O} is more effective in the low-dropout linear regulator of the invention.

At time t5, the output voltage starts to increase to a steady state after reaching the minimum value. As shown in FIG. 6, during the period between time t5 and t6, with the cooperation of the first feedback loop and the second feedback loop, the output voltage Vo of the low-dropout linear regulator of the invention may increase and return to a steady state at a faster speed than the output voltage V_{O}′ of the conventional low-dropout linear regulator, thereby significantly reducing the response time of the low-dropout linear regulator.

In embodiments of the invention, with a negative feedback formed by the second feedback loop including a differentiating circuit, a variation in the output voltage can be responded to faster. Since the second feedback loop may rapidly suppress variations of the output voltage of the low-dropout linear regulator, the output voltage of the low-dropout linear regulator can keep steady more effectively by the second feedback loop. In addition, in the steady state, the second feedback loop is disconnected from the output transistor, and the differential circuit is isolated from the output circuit, thereby preventing interference to the output voltage.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A low-dropout linear regulator, comprising:
a voltage divider, configured to generate a feedback voltage according to an output voltage of the low-dropout linear regulator;
a first error amplifier, configured to compare the feedback voltage with a reference voltage, and output a first voltage at an output terminal of the first error amplifier according to the comparison result;
an output transistor, comprising a first terminal and a second terminal, wherein the first terminal is coupled to the output terminal of the first error amplifier and receives the first voltage, and the second terminal is coupled to the voltage divider and outputs the output voltage;
a differential circuit, configured to receive the feedback voltage and the reference voltage, and to generate a second voltage at an output terminal of the differential circuit; and
a control circuit, coupled between the output terminal of the differential circuit and the first terminal of the output transistor, and configured to adjust a voltage on the first terminal of the output transistor according to variation of the second voltage on the output terminal of the differential circuit.

2. The low-dropout linear regulator as claimed in claim 1, wherein the control circuit comprises a detecting and switching circuit configured to connect the output terminal of the differential circuit to the first terminal of the output transistor when the second voltage exceeds a predetermined voltage range.

3. The low-dropout linear regulator as claimed in claim 1, wherein the control circuit comprises a first capacitor, and the first voltage received by the first terminal of the output transistor follows the second voltage via the first capacitor.

4. The low-dropout linear regulator as claimed in claim 1, wherein the differential circuit comprises:
an amplifier, comprising a first input terminal, a second input terminal, and an output terminal, wherein the first input terminal of the amplifier receives the reference voltage, and the output terminal of the amplifier is used as the output terminal of the differential circuit;
a second capacitor, wherein a first terminal of the second capacitor receives the feedback voltage, and a second terminal of the second capacitor is coupled to the second input terminal of the amplifier; and
a first resistor, coupled between the second input terminal and the output terminal of the amplifier.

5. The low-dropout linear regulator as claimed in claim 4, wherein the amplifier of the differential circuit is a second error amplifier, and the first input terminal of the amplifier is a positive input terminal of the second error amplifier, and the second input terminal of the amplifier is a negative input terminal of the second error amplifier.

6. The low-dropout linear regulator as claimed in claim 2, wherein the detecting and switching circuit comprises a detecting component and a switching component, and the detecting component is configured to detect whether the second voltage output from the differential circuit is within a predetermined voltage range;
wherein if the second voltage exceeds the predetermined voltage range, the switching component is turned on, and the output terminal of the differential circuit is connected to the first terminal of the output transistor;
wherein if the second voltage is within the predetermined voltage range, the switching component is turned off, and the output terminal of the differential circuit is disconnected from the first terminal of the output transistor.

7. The low-dropout linear regulator as claimed in claim 1, further comprising:
a buffer, coupled between the output terminal of the first error amplifier and the first terminal of the output transistor.

8. The low-dropout linear regulator as claimed in claim 1, wherein the voltage divider comprises a second resistor and a third resistor, wherein a first terminal of the second resistor is connected to the second terminal of the output transistor, and a second terminal of the second transistor is connected to a first terminal of the third resistor, and a second terminal of the third resistor is connected to the ground,
wherein the second terminal of the second resistor and the first terminal of the third resistor outputs the feedback voltage.

9. The low-dropout linear regulator as claimed in claim 1, wherein the output transistor is an NMOSFET, and the first terminal, the second terminal, and the third terminal of the output transistor is a gate, a source, and a drain of the NMOSFET, respectively.

10. The low-dropout linear regulator as claimed in claim 1, wherein the output transistor is an NPN transistor, and the first terminal, the second terminal, and the third terminal of the output transistor is a base, an emitter, and a collector of the NPN transistor, respectively.

11. A low-dropout linear regulator, comprising:
a voltage divider, a first negative feedback loop, a second negative feedback loop, and an output transistor, wherein
the voltage divider is configured to generate a feedback voltage according to an output voltage of the low-dropout linear regulator;
the first negative feedback loop comprises an error amplifier and is configured to receive the feedback voltage and a reference voltage, and compare the feedback voltage with the reference voltage to output a first voltage;
the second negative feedback loop comprises a differential circuit and a control circuit, and the differential circuit is configured to receive the feedback voltage and the reference voltage to generate a second voltage, and the control circuit is configured to adjust a voltage on the first terminal of the output transistor according to variation of the second voltage on the output terminal of the differential circuit; and
the output transistor comprises a first terminal and a second terminal, and the first terminal of the output transistor is coupled to an output terminal of the error amplifier and the control circuit and is configured to receive the first voltage and the second voltage, and the second terminal of the output transistor is used as an output terminal of the low-dropout linear regulator.

12. The low-dropout linear regulator as claimed in claim 11, wherein the control circuit comprises a detecting and switching circuit configured to connect an output terminal of the differential circuit to the first terminal of the output transistor when the second voltage exceeds a predetermined voltage range.

13. The low-dropout linear regulator as claimed in claim 12, wherein the detecting and switching circuit comprises a detecting component and a switching component, and the detecting component is configured to detect whether the second voltage output from the differential circuit is within the predetermined voltage range;
wherein if the second voltage exceeds the predetermined voltage range, the switching component is turned on, and the output terminal of the differential circuit is connected to the first terminal of the output transistor;
wherein if the second voltage is within the predetermined voltage range, the switching component is turned off, and the output terminal of the differential circuit is disconnected from the first terminal of the output transistor.

14. The low-dropout linear regulator as claimed in claim 11, wherein the control circuit comprises a first capacitor, and the first voltage received by the first terminal of the output transistor follows the second voltage via the first capacitor.

15. The low-dropout linear regulator as claimed in claim 11, wherein the differential circuit comprises:
an amplifier, comprising a first input terminal, a second input terminal, and an output terminal, wherein the first input terminal of the amplifier receives the reference voltage, and the output terminal of the amplifier is used as the output terminal of the differential circuit;
a second capacitor, wherein a first terminal of the second capacitor receives the feedback voltage, and a second terminal of the second capacitor is coupled to the second input terminal of the amplifier; and
a first resistor, coupled between the second input terminal and the output terminal of the amplifier.
